(19) United States
(12) Patent Application Publication
(10) Pub. No.: US 2023/0087986 A1
(43) Pub. Date: Mar. 23, 2023

(54) INSERTING CODE INTO A DOCUMENT OBJECT MODEL OF A GRAPHICAL USER INTERFACE TO ENABLE SUB-EXCHANGES

(71) Applicant: Capital One Services, LLC, McLean, VA (US)

(72) Inventor: Margaret CROUSE, Burke, VA (US)

(21) Appl. No.: 17/448,312

(22) Filed: Sep. 21, 2021

(51) Int. Cl. G06Q 30/06; G06F 40/151; G06F 3/0482; G06F 3/0484; G06K 7/14

(52) U.S. Cl. CPC G06Q 30/0641; G06F 40/151; G06F 3/0482; G06F 3/04847; G06K 7/1417

(57) ABSTRACT

In some implementations, a device may receive, via a non-textual image, presentation information indicating a set of items, an amount associated with each item included in the set of items, and a total amount associated with an exchange. The device may insert code into a document object model (DOM) of the GUI based on the presentation information to display, via the GUI, one or more user selection options that enable a selection of an item, from the set of items, and a selection of a portion of an amount associated with a selected item. The device may receive, via the GUI, a user selection that indicates one or more selected items and a portion of an amount for the selected item. The device may transmit, to a server device, credential information associated with an exchange medium to cause a transfer associated with the sub-exchange to be completed.

### BACKGROUND

A display of a device may display a user interface (e.g., a graphical user interface (GUI)). A GUI is a form of user interface that allows users to interact with electronic devices. A user interface may permit interactions between a user of the device and the device. In some cases, the user may interact with the user interface to operate and/or control the device to produce a desired result. For example, the user may interact with the device to cause the device to perform an action. Additionally, the user interface may provide information to the user.

### SUMMARY

Some implementations described herein relate to a non-transitory computer-readable medium that stores a set of instructions for providing a graphical user interface (GUI) to enable sub-exchanges by inserting code into a document object model of the GUI for a device. The set of instructions, when executed by one or more processors of the device, may cause the device to receive presentation information indicating a set of items associated with an exchange, an amount associated with each item included in the set of items, and a total amount associated with the exchange. The set of instructions, when executed by one or more processors of the device, may cause the device to insert the code into the document object model of the GUI based on the presentation information, wherein the code causes an indication of the set of items, the amount associated with each item, and the total amount to be provided for display by the GUI. The set of instructions, when executed by one or more processors of the device, may cause the device to provide the GUI for display by the device based on inserting the code into the document object model. The set of instructions, when executed by one or more processors of the device, may cause the device to receive, via the GUI, an indication of a user selection that indicates one or more items, from the set of items, and a portion of an amount for each item of the one or more items. The set of instructions, when executed by one or more processors of the device, may cause the device to modify the code to cause information for a sub-exchange associated with the exchange to be provided for display by the GUI, wherein the information for the sub-exchange indicates the one or more items, an amount for each item that is based on the portion of the amount, and a total amount associated with the sub-exchange. The set of instructions, when executed by one or more processors of the device, may cause the device to provide the GUI for display by the device based on modifying the code. The set of instructions, when executed by one or more processors of the device, may cause the device to transmit, to a server device, credential information associated with an exchange medium to cause a transfer associated with the sub-exchange to be completed.

Some implementations described herein relate to a method of providing a GUI to enable sub-exchanges. The method may include receiving, by a device and via a non-textual image, presentation information indicating a set of items associated with an exchange, an amount associated with each item included in the set of items, and a total amount associated with the exchange. The method may include displaying, by the device and via the GUI, an indication of the set of items, the amount associated with each item included in the set of items, the total amount, and one or more user selection options that enable a selection of an item, from the set of items, and a selection of a portion of an amount associated with a selected item. The method may include receiving, by the device and via the GUI, a user selection that indicates one or more selected items, from the set of items, and a portion of an amount for at least one selected item of the one or more selected items. The method may include displaying, by the device and via the GUI, information associated with a sub-exchange associated with the exchange, wherein the information associated with the sub-exchange indicates the one or more selected items and a total amount associated with the one or more selected items, wherein the total amount associated with the one or more selected items is based on the portion of the amount for the at least one selected item indicated by the user selection. The method may include transmitting, by the device and to a server device, credential information associated with an exchange medium to cause a transfer associated with the sub-exchange to be completed for the total amount associated with the one or more selected items.

Some implementations described herein relate to a system for providing a GUI to enable sub-exchanges. The system may include one or more memories and one or more processors coupled to the one or more memories. The one or more processors may be configured to provide, to one or more user devices, presentation information associated with an exchange, wherein the presentation information identifies a set of items associated with the exchange, an amount associated with each item included in the set of items, and a total amount associated with the exchange, and wherein providing the presentation information causes the presentation information to be displayed via GUIs of the one or more user devices. The one or more processors may be configured to receive, from a first user device of the one or more user devices, information for a first sub-exchange associated with the exchange, wherein the information for the first sub-exchange includes an indication of a first one or more items from the set of items, a portion of an amount associated with each item of the first one or more items, and first credential information associated with a first exchange medium to be used to complete a first transfer for the first sub-exchange, wherein the portion of the amount associated with an item of the first one or more items is less than a total portion of the amount associated with the item. The one or more processors may be configured to communicate, with a backend system, to initiate the first transfer for the first sub-exchange based on the first credential information. The one or more processors may be configured to update the presentation information associated with the exchange, to updated presentation information, based on communicating to initiate the first transfer. The one or more processors may be configured to provide, to the one or more user devices, the updated presentation information associated with the exchange, wherein the updated presentation information identifies the set of items associated with the exchange, an updated amount associated with each item of the set of items, and an updated total amount associated with the exchange based on receiving the information for the first sub-exchange.

### BRIEF DESCRIPTION OF THE DRAWINGS

FIGS. 1A-1E are diagrams of an example implementation relating to inserting code into a document object model (DOM) of a graphical user interface (GUI) to enable sub-exchanges.

FIG. 2 is a diagram of an example environment in which systems and/or methods described herein may be implemented.

FIG. 3 is a diagram of example components of one or more devices of FIG. 2.

FIGS. 4 and 5 are flowcharts of example processes relating to inserting code into a DOM of a GUI to enable sub-exchanges.

### DETAILED DESCRIPTION

The following detailed description of example implementations refers to the accompanying drawings. The same reference numbers in different drawings may identify the same or similar elements.

Transaction terminals may be used to complete payment transactions at various vendor locations. In some cases, a group of users may place an order. For example, the group of users may sit at a table and place an order for a meal at a restaurant. A vendor employee may access a transaction terminal to generate and print one bill or receipt for a total payment for the order, which may be presented to the group of users placing the order. In some cases, the vendor employee may be asked to split the receipt among users in the group of users. In this case, the vendor employee must then manually split the receipt into multiple receipts based on instructions from the users. The vendor employee may then manually interface multiple payment mediums (e.g., multiple transaction cards, or a combination of transaction cards, a check, and/or cash) with the transaction terminal to satisfy the total payment for the order. Manually splitting the receipt into multiple receipts and manually processing multiple transaction cards is both time and labor intensive. Moreover, relying on the vendor employee to accurately split the receipt into the multiple receipts and process the multiple transaction cards may lead to errors. For example, a user may erroneously pay for an item that was not ordered by the user or a wrong transaction card may be processed for a wrong amount. Further, processing multiple transactions for the single order consumes time and resources associated with completing each transaction for the order (e.g., the transaction terminal must communicate with a backend server to request approval for each transaction associated with the order).

As a transaction terminal may be capable of accepting only a single payment medium (e.g., a single transaction card) for a transaction, the request to approve the transaction from the vendor may identify only a single transaction card or a single account. Therefore, the backend server associated with an institution may be enabled to associate the transaction with only the single transaction card or the single account. To complete a transaction using multiple accounts, a user may be required to initiate multiple transactions at a transaction terminal (e.g., each transaction being initiated using a different transaction card or a different payment medium) to enable the transaction terminal to transmit separate requests to the backend server. However, completing multiple transactions using multiple transaction cards or payment mediums consumes additional overhead associated with completing the multiple transactions. Moreover, completing multiple transactions using multiple transaction cards or payment mediums requires the backend server to settle multiple transactions with the vendor, creating additional complexity and additional overhead associated with settling the multiple transactions.

In some cases, the group of users may utilize a third party application or service to split the order (such as a payment application). For example, a single user from the group of users may present a payment medium (e.g., a transaction card, a check, or cash) to complete a single transaction for the order. The single user may then use the third party application or service to collect payments from the other users from the group of users to repay the single user for portions of the order. However, using the third party application or service requires that the single user coordinate with each of the other users after the single user has accepted a charge for the entire order. As a result, using the third party application or service is time and labor intensive as the single user may be required to determine a portion of the order to allocate to each other user, request a payment from each of the other users via the third party application or service, and wait for each of the other users to confirm the payment and transfer resources to the user via the third party application or service. Additionally, the user may be required to transfer resources from the third party application or service to an account that the user used to complete the transaction for the order. This consumes significant time and processing resources associated with requesting payments, receiving payments, and transferring the resources to another account. Moreover, in some cases, another user may deny or not complete the payment to the single user, resulting in the single user being responsible for the other user's portion of the order (e.g., as the single user has already paid for the entire order using resources associated with the user). Further, this requires a user to share sensitive information with the third party application or service, such as account information, an account number, and/or a routing number, among other examples. As a result, a security risk is introduced by the user sharing the sensitive information with the third party application or service.

In some cases, the group of users may utilize direct transfers to split a transaction or an order. For example, a first user may directly transfer resources to an account of the user that paid for the transaction or the order. However, this requires a user to share sensitive information with the other users, such as account information, an account number, and/or a routing number, among other examples. As a result, a security risk is introduced by the user sharing the sensitive information with the other users.

In some cases, a single item associated with a transaction may be associated with multiple users. For example, a food item may be split among multiple users associated with a transaction. This may introduce additional complexity associated with splitting a transaction because a transaction terminal may be capable of splitting a total amount of a transaction (e.g., 25% of the total amount charged to each user), but splitting an amount associated with individual items may not be possible. For example, the transaction terminal may not be capable of adjusting or splitting these amounts for particular transactions. Therefore, splitting amounts for individual items of a transaction, when the transaction is to be split among multiple users, may introduce additional complexity and may consume time and processing resources associated with identifying an amount to be associated with each user. Additionally, when items associated with a transaction are split among multiple users, some items may not be claimed or be paid for by any of the users. As a result, the transaction terminal may be required to determine how to allocate the amount for the items that are not claimed or not paid for by any of the users. This may consume processing resources and/or computing resources associated with determining credential information (e.g., transaction card information) to be associated with the remaining items, determining an allocation of the remaining amount associated with the transaction (e.g., a percentage or amount of the remaining amount to be allocated to one or more users), requesting one or more payments for the remaining amount, receiving one or more payments for the remaining amount, and/or settling multiple transactions, thereby creating additional complexity and additional overhead associated with settling the transaction.

To address one or more of the problems described above, some implementations described herein enable a device (e.g., a user device) to insert code into a document object model (DOM) of a graphical user interface (GUI) of the device to enable sub-exchanges (e.g., sub-transactions) associated with a transaction. For example, the GUI may display information indicating a set of items associated with an exchange (e.g., a transaction), an amount associated with each item included in the set of items, and a total amount associated with the exchange. A user may input, via the GUI, one or more user selections selecting one or more items, from the set of items, and indicating an amount to be paid by the user for each item selected (e.g., for each of the one or more items). For example, an exchange may be associated with an item A, an item B, and an item C. A user may select, via the GUI, item A and item B to be at least partially paid for by the user. The user may also indicate that 100% of the amount of item A is to be associated with the user (e.g., paid for by the user) and 50% of the amount of item B is to be associated with the user. The device, based on receiving the user selections, may generate a sub-exchange for the selected items and for the portions of the amounts of the selected items as indicated by the user (e.g., a sub-exchange for 100% of item A and 50% of item B). The device may receive, via the GUI, credential information (e.g., payment information, credit card information, and/or transaction device information). The device may communicate with a transaction terminal associated with the exchange to complete a payment for the sub-exchange. The device and/or the transaction terminal may then cause updated exchange information to be displayed associated with the exchange. For example, another user device associated with the exchange may receive the updated exchange information and may display, via a GUI of the other user device, the updated exchange information. The updated exchange information may cause items that have been paid for (e.g., 100% paid for) by another user to be not available for selection via the GUI. Additionally, the updated exchange information may cause an updated amount, or an updated portion associated with the amount, for an item to be displayed based on another user paying a portion (e.g., that is less than 100%) of the amount associated with the item. As a result, another user may use the other user device to initiate and/or complete another sub-exchange (e.g., in a similar manner as described above), while also ensuring that items are not paid for twice and/or ensuring that an amount paid for an individual item does not exceed 100%.

In some implementations, one or more items may not be claimed, or paid for, by sub-exchanges associated with the exchange. In such examples, the transaction terminal may identify credential information for one or more users that completed sub-exchanges associated with the exchange. The transaction terminal may identify a total amount associated with the unclaimed items associated with the exchange. The transaction terminal may automatically split the total amount among the one or more users that completed sub-exchanges associated with the exchange (e.g., equally or by an amount indicated via a GUI of at least one user device associated with the exchange). For example, the transaction terminal (e.g., without receiving additional communications or signaling from the user device or another device or without receiving additional input from a user) may cause one or more transactions to be completed (e.g., using the credential information for one or more users that completed sub-exchanges associated with the exchange) to ensure that each item that is not claimed by the sub-exchange(s) is paid for. In some implementations, the transaction terminal may transmit a message, to at least one user device associated with a sub-exchange, to request a payment for the unclaimed items. In some implementations, the transaction terminal may cause an alert or notification to be transmitted or displayed (e.g., to enable an employee of the vendor or merchant associated with the exchange to view the alert or notification) based on determining that one or more items were not paid for by sub-exchanges associated with the exchange. As a result, the transaction terminal may be enabled to handle settling amounts associated with unclaimed items associated with an exchange that is split amount multiple users. This may conserve processing resources and/or computing resources that would have otherwise been used to determine credential information (e.g., transaction card information) to be associated with the unclaimed items, determine an allocation of the remaining amount associated with the transaction (e.g., a percentage or amount of the remaining amount to be allocated to one or more users), request payments for the remaining amount, receive payments for the remaining amount, and/or settle multiple transactions associated with the exchange, among other examples.

As a result, a DOM of a GUI of one or more user devices may be modified via code to enable the GUI to display presentation information that enables a user to select individual items associated with an exchange and enables the user to select a portion (e.g., a percentage) of an amount associated with each selected item that is to be associated with a sub-exchange. As a result, the user device and/or a transaction terminal may be enabled to generate a sub-exchange based on the user selections provided via the GUI. Information associated with the sub-exchange may be displayed via the GUI. The GUI may enable the user to submit payment information (e.g., credential information for a transaction device) to complete a payment associated with the sub-exchange generated for the user. As a result, the systems described herein make data easier to access by enhancing a user interface, thereby improving a user experience, improving a user efficiency, enhancing user-friendliness of a user device and the user interface, and improving the ability of a user to use the user device. In some implementations, data associated with an exchange and generated sub-exchanges is presented in a unified manner via a user interface (as opposed to a scenario where data is presented on separate pages or on separate physical receipts), thereby further improving access to the data. For example, information associated with a generated sub-exchange may be quickly presented via the GUI (e.g., by modifying or inserting code into the DOM of the GUI) to the user after user selections in a more efficient manner (e.g., rather than the information being determined by a transaction terminal, the transaction terminal generating new information, the transaction terminal causing the new information to be printed on a receipt, and the user waiting for the receipt to the delivered). Therefore, systems described herein enable a GUI that improves efficiency and user-friendliness associated with splitting an exchange among multiple users. Additionally, the systems described herein can improve data security by reducing a quantity of times that a user device transmits personal information of a user via a network. Additional details and advantages are described below.

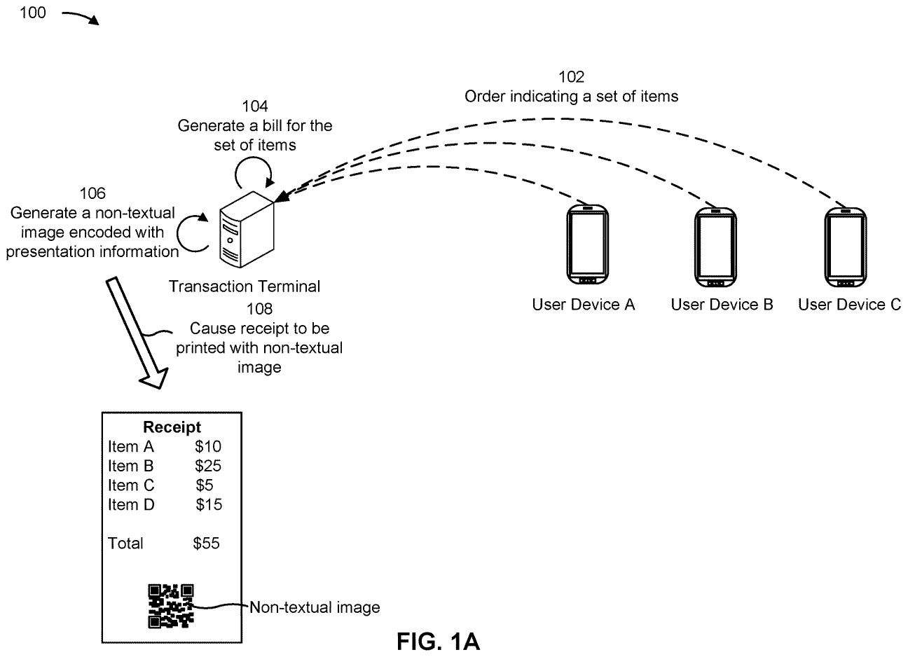

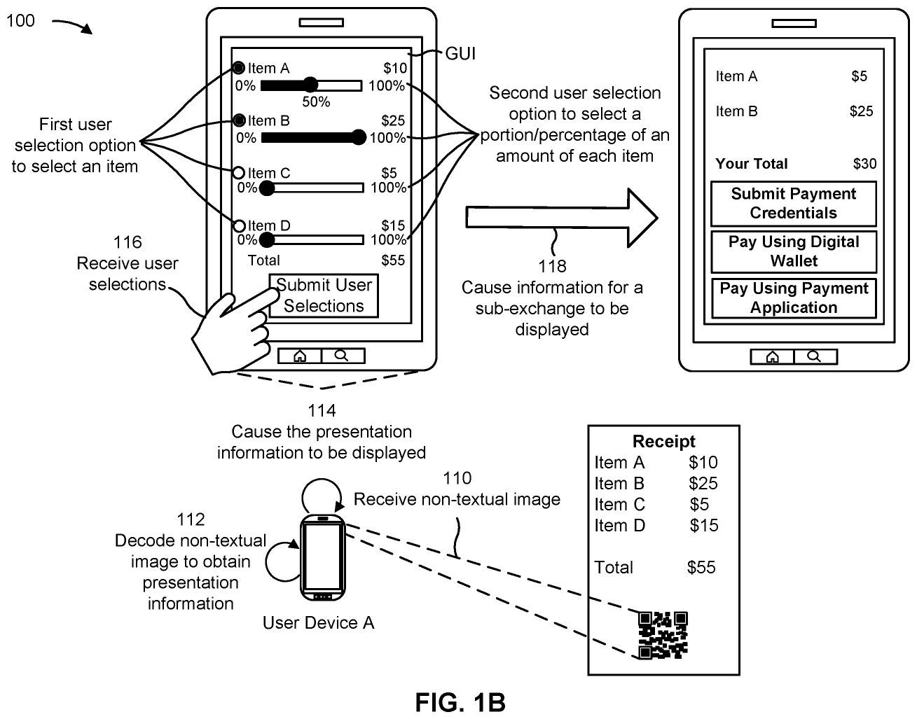

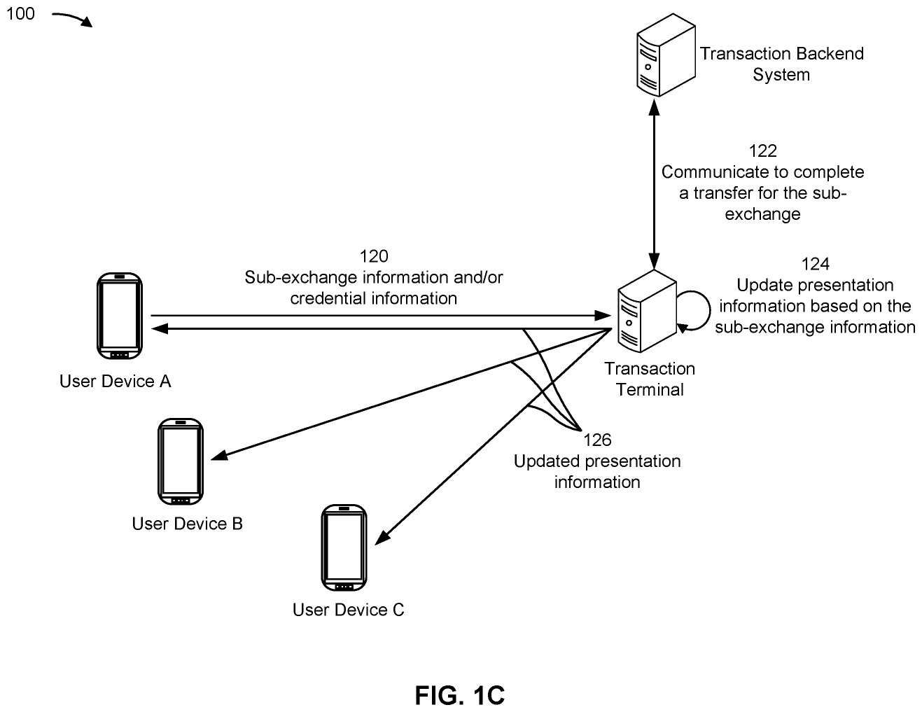

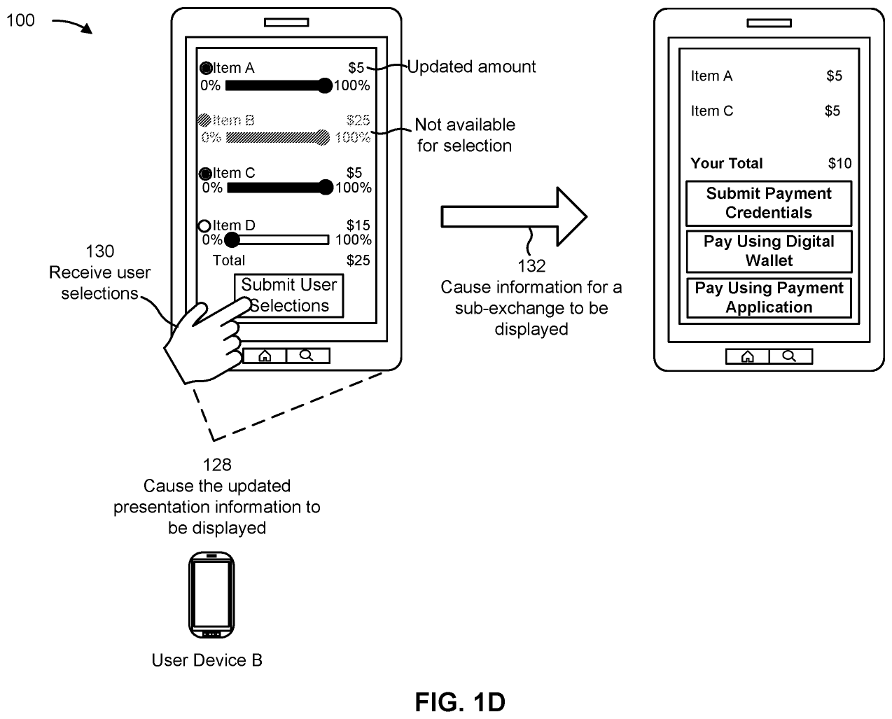

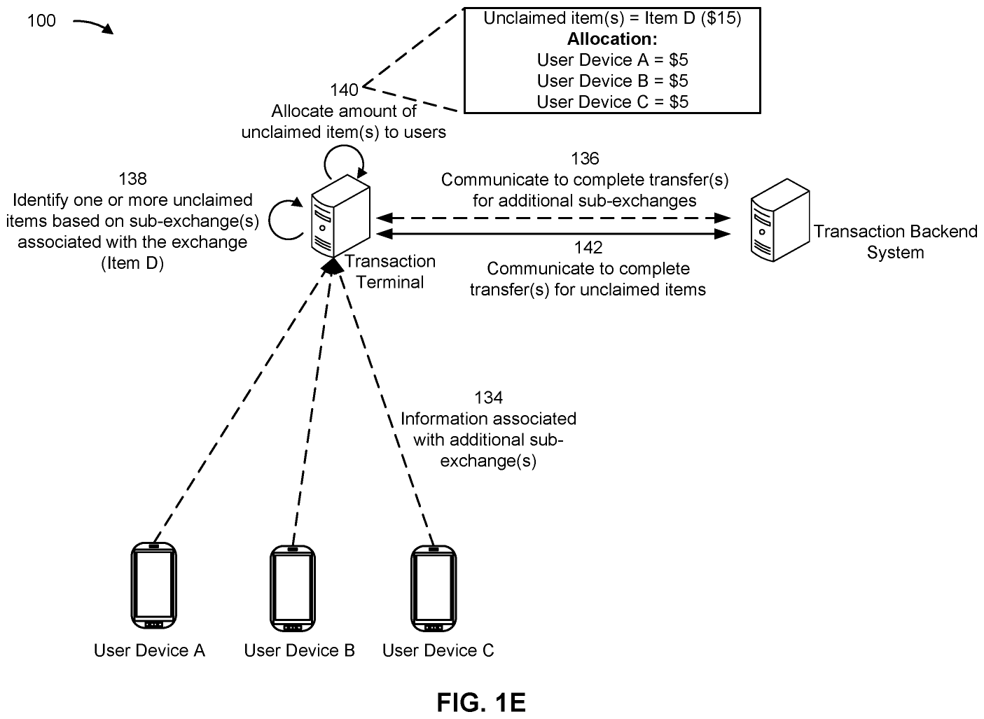

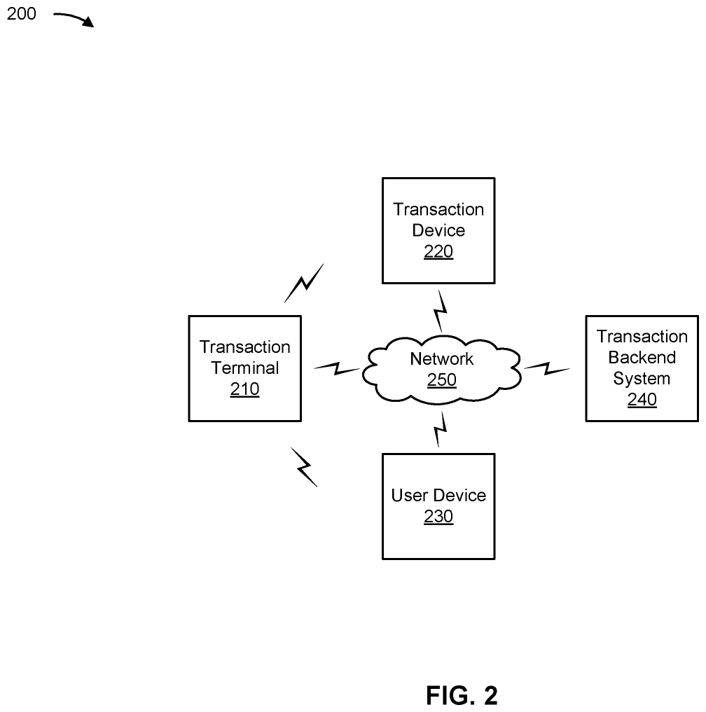

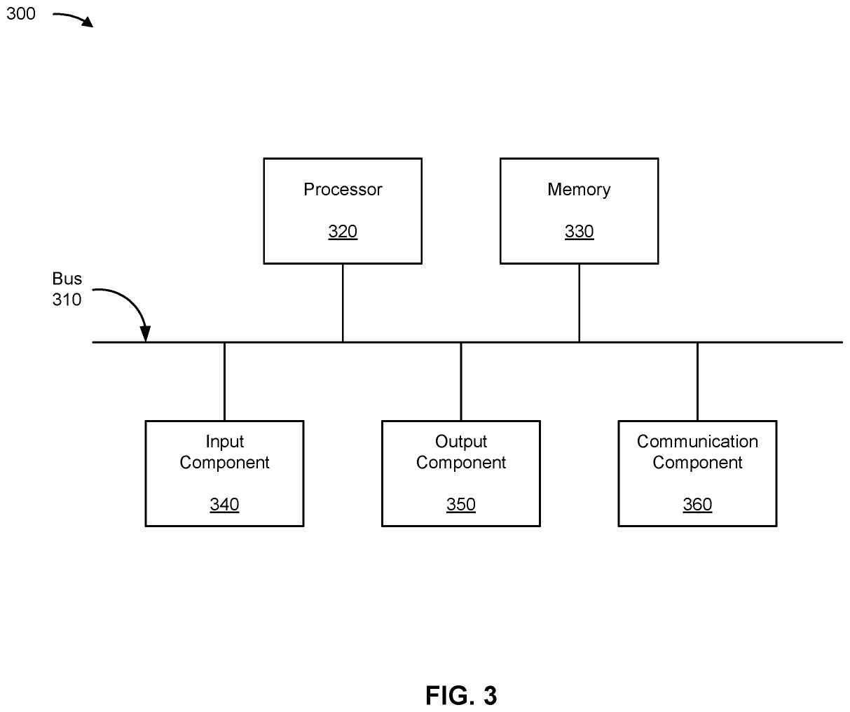

FIGS. 1A-1E are diagrams of an example 100 associated with inserting code into a DOM of a GUI to enable sub-exchanges. As shown in FIGS. 1A-1E, example 100 includes one or more user devices (e.g., user device A, user device B, and user device C), a transaction terminal, and a transaction backend system. These devices are described in more detail in connection with FIGS. 2 and 3.

In some implementations, one or more actions described herein as being performed by a user device or the transaction terminal may be performed via an application executing on the user device and/or executing on the transaction terminal. For example, the user device(s) (e.g., user device A, user device B, and user device C) may download and/or install the application. Similarly, the transaction terminal may download and/or install the application. The application may enable the transaction terminal to communicate with and/or exchange information with the user device(s), as described herein. In some implementations, the application executing on the user device(s) and the application executing on the transaction terminal may be different applications or may be different versions of the same application. In some implementations, the application may be associated with, provided by, and/or managed by an institution, such as a financial institution. For example, the institution may provide the application to entities (e.g., merchants and/or vendors) to enable the entities to offer a service associated with splitting a bill via sub-exchanges, as described herein. In some implementations, rather than an application executing on the user device(s), the user device(s) may perform one or more actions described herein via a web page or another GUI that is displayed via the user device(s).

As used herein, “exchange” may refer to a transaction, an electronic exchange, a sale, and/or a transfer, among other examples. For example, “exchange” and “transaction” may be used interchangeably herein. As used herein, “sub-exchange” may refer to an exchange that is associated with a subset of items, from a set of items, associated with another exchange. In some implementations, a sub-exchange may be associated with a portion (e.g., that is less than a full portion or 100%) of an amount associated with an item, as described herein. As used herein, “exchange medium” may refer to a transaction device, a physical exchange medium, a payment device, a transaction card, a credit card, a debit card, a payment application executing on a user device, and/or a digital wallet associated with a user device, among other examples.

As shown in FIG. 1A, the transaction terminal may receive an indication of a set of items associated with an exchange. For example, in some implementations as shown by reference number 102, the transaction terminal may receive the indication of the set of items associated with the exchange from the one or more user devices (e.g., user device A, user device B, and/or user device C). For example, an application executing on a user device, or a web page displayed via the user device, may enable a user to input a selection of an item associated with the exchange. For example, the user device A, the user device B, and the user device C may be associated with users who are ordering a meal from the same table (e.g., such that the exchange is associated with all the users). Each user, via a respective user device, may input an order (e.g., by selecting one or more items via a GUI or web page displayed via the user device). The transaction terminal may receive the orders from each user device and may aggregate the items indicated by each item to determine the set of items associated with the exchange. Alternatively, the transaction terminal may receive the indication of the set of items associated with the exchange via an input to the transaction terminal (e.g., from an employee of an entity associated with the transaction terminal).

The transaction terminal may perform one or more actions based on receiving the indication of the set of items associated with the exchange. For example, the transaction terminal may transmit a message to another device to cause an order associated with the set of items to be initiated. In the example where the set of items are food items, the transaction terminal may cause a notification of the set of items to be displayed or printed on a paper receipt to enable employees in a kitchen to identify the set of items and begin preparing the set of items. As shown by reference number 104, the transaction terminal may generate a bill for the set of items. The bill may indicate each item associated with the exchange, an amount associated with each respective item (e.g., an item amount), and an amount associated with the exchange (e.g., a total amount), among other examples. The total amount may include each item amount summed and may take other factors into account, such as a tax amount and/or gratuity, among other examples. For example, the bill may be an itemized list of the items associated with the exchange indicating an item amount associated with each item, and/or the total amount associated with the exchange.

As shown by reference number 106, the transaction terminal may generate a non-textual image encoded with presentation information that is based on the bill. For example, the presentation information may indicate the set of items associated with the exchange, the item amount associated with each item included in the set of items, and the total amount associated with the exchange, among other examples. In some implementations, the presentation information may be code, that when inserted into a DOM, causes a device, such as a user device, to display an indication of the set of items associated with the exchange, the item amount associated with each item included in the set of items, and the total amount associated with the exchange, among other examples. In some implementations, the presentation information may include information that causes one or user selection options to be displayed by a user device (e.g., when the presentation information is received by the user device, as described in more detail elsewhere herein).

The transaction terminal may encode a non-textual image with the presentation information. For example, the non-textual image may be a Quick Response (QR) code or another image that, when received or scanned by a user device, enables the user device to decode the non-textual image and obtain the presentation information. In some implementations, as shown by reference number 108, the transaction terminal may cause a receipt to be printed, for the exchange, that includes the encoded non-textual image. For example, the transaction terminal may transmit, to a printer device, a command that causes the printer device to print the receipt with the encoded non-textual image. As shown in FIG. 1A, the receipt may indicate the set of items associated with the exchange (e.g., Item A, Item B, Item C, and Item D), an item amount associated with each item (e.g., $10 for Item A, $25 for Item B, $5 for Item C, and $15 for Item D), and a total amount associated with the exchange (e.g., $55).

In some other implementations, the transaction device may provide the presentation information to the user device(s) associated with the exchange in another manner. For example, in some implementations, the transaction device may provide the presentation information to the user device(s) associated with the exchange via an application executing on the transaction terminal and the user device(s). In some implementations, the transaction terminal may transmit, and the user device(s) may receive, a message that includes the presentation information to cause information associated with the exchange to be displayed by the user devices(s), as described in more detail elsewhere herein.

As shown in FIG. 1B, a user device associated with the exchange (e.g., shown as user device A in FIG. 1B) may receive the presentation information associated with the exchange. For example, the user device may receive the presentation information via a message from the transaction terminal and/or via an application executing on the user device. In some implementations, as shown by reference number 110, the user device may receive the non-textual image encoded with the presentation information that is printed on a receipt associated with the transaction. For example, the user device may scan the non-textual image via a camera device associated with, or included in, the user device. As shown by reference number 112, the user device may decode the non-textual image to obtain the presentation information. For example, the non-textual image may be a QR code that, when scanned by the user device, causes the user device to decode the non-textual image to obtain the presentation information. In some implementations, receiving the presentation information (e.g., via the application, the non-textual image, and/or the message from the transaction terminal) may cause the user device to perform one or more actions. For example, receiving the presentation information may cause an application to execute on the user device (e.g., the application that is associated with enabling sub-exchanges, as described herein). In some implementations, receiving the presentation information may cause the user device to display a hyperlink to a web page associated with enabling sub-exchanges, as described herein.

In some implementations, as shown by reference number 114, the user device may insert code into a DOM of a GUI associated with the user device based on receiving the presentation information. For example, the user device may insert code into a document used to generate a web page or an application page (e.g., a DOM) based on the presentation information. The code may include hypertext markup language (HTML) code, cascading style sheet (CSS) code, a script, or any other code capable of causing the web page to present information. After the code is inserted, the client device may provide the web page for presentation and/or may present the web page for display. Insertion of the code may cause the page to be presented differently than if the page were presented without the code. For example, insertion of the code may cause the user device to display, via a GUI associated with the user device, an indication of the set of items associated with the exchange, an item amount associated with each item included in the set of items, a total amount associated with the exchange, and one or more user selection options for enabling sub-exchanges associated with the exchange, as described in more detail elsewhere herein.

In some implementations, the reception of the presentation information may cause the user device to navigate to a page (e.g., a web page or a page of an application executing on the user device) that displays the presentation information, as described herein and as depicted in FIG. 1B. For example, the presentation information received by the user device may include instructions that cause the user device to open a web page, present a hyperlink to a web page, and/or to open an application executing on the user device. For example, the reception of the presentation information may cause the user device to display a request to open an application executing on the user device. The user device may open the application (or a page of the application) based on receiving a user input indicating an approval to open the application. Navigating to the web page or executing the application (or opening a page associated with the application) may cause the user device to display, via the GUI, an indication of the set of items associated with the exchange, an item amount associated with each item included in the set of items, a total amount associated with the exchange, and one or more user selection options for enabling sub-exchanges associated with the exchange, as described in more detail elsewhere herein.

For example, as shown in FIG. 1B, the user device may display, via the GUI, an indication of the set of items (e.g., Item A, Item B, Item C, and Item D). The user device may display, via the GUI, an item amount associated with each item (e.g., $10 for Item A, $25 for Item B, $5 for Item C, and $15 for Item D). The user device may display, via the GUI, the total amount associated with the exchange (e.g., $55). As shown in FIG. 1B, the page displayed via the GUI may be a first page associated with a main bill associated with the exchange (e.g., indicating information for all items associated with the exchange)

Additionally, the user device may display one or more user selection options that enable sub-exchanges to be generated for the exchange. For example, the user device may display a first user selection option to enable a selection of an item from the set of items. For example, as shown in FIG. 1B, a user associated with the user device may input a user selection that indicates that Item A and Item B are selected. This may indicate that the user intends to generate a sub-exchange associated with the exchange and Item A and Item B.

As further shown in FIG. 1B, the user device may display a second user selection option that enables a selection of a portion of an item amount associated with each item. For example, as shown in FIG. 1B, each item associated with the exchange may include an option to indicate a portion of an item amount (e.g., from 0% to 100%) to be associated with the sub-exchange. The second user selection option may be a variable percentage option, such as a sliding bar, for indicating a portion or percentage e.g., from 0% to 100%) associated with an amount of each item to be associated with the sub-exchange. In some implementations, the second user selection option may enable a user to input a value (e.g., an amount to be associated with the sub-exchange) or input a portion or percentage of the item amount to be associated with the sub-exchange. In some implementations, the second user selection option may have a default value. For example, when an item is selected by a user (e.g., via the first user selection option), the default value may be the item amount or 100%. When an item is not selected by the user (e.g., via the first user selection option), the default value may be $0 or 0%. This may reduce a complexity associated with user input options for the GUI because the amount to be paid for an item may automatically be set to 100% when the item is selected and may be set to 0% when an item is not selected (e.g., thereby only requiring a user to adjust the second user selection option when the amount to be paid for an item is greater than 0% of the item amount but less than 100% of the item amount). The second user selection option may increase a user-friendliness associated with the GUI because a variable portion may be input by a user, thereby enabling more customizable input options (e.g., as compared to an all or nothing approach or an equal splitting of items associated with multiple users) for items that are to be paid for by multiple users.

As shown by reference number 116, the user device may receive one or more user selections. For example, the user device may receive the one or more user selections via the one or more user selection options displayed via the GUI. The one or more user selection options may indicate one or more items, from the set of items, and a portion of an amount for each item of the one or more items to be associated with a sub-exchange. For example, the user selections may indicate a subset of items from the set of items (e.g., Item A and Item B, as shown in FIG. 1B). Additionally, the user selections may indicate, for each item included in the subset of items, a portion of the item amount to be associated with the sub-exchange. For example, the user selections may indicate that 50% of the item amount for Item A is to be associated with the sub-exchange (e.g., 50% of $10, or $5) and may indicate that 100% of the item amount for Item B is to be associated with the sub-exchange (e.g., 100% of $25).

As shown by reference number 118, the user device may cause information for the sub-exchange to be displayed (e.g., via the GUI). For example, in some implementations, the user device may modify the code inserted into, or may insert new code into, the document (e.g., the DOM) used to generate the page being displayed by the user device to cause the page to display the information associated with the sub-exchange. As shown in FIG. 1B, the second page displayed via the GUI may be associated with a sub-bill (e.g., for items selected by the user as described above). In some implementations, the user device may transmit, and the transaction terminal may receive, an indication of the information associated with the sub-exchange. This may enable the transaction terminal to generate a bill for the sub-exchange. Additionally, this may enable the transaction terminal to generate presentation information for the sub-exchange (e.g., indicating the subset of items associated with the sub-exchange, the amounts associated with each item of the sub-exchange, and/or a total amount associated with the sub-exchange). In some implementations, receiving the one or more user selection options may cause the user device to navigate to a new web page or to open a new page associated with an application executing on the user device. The new web page or the new page may display the information associated with the sub-exchange, as shown in FIG. 1B.

For example, as shown in FIG. 1B, the user device may display an indication of the subset of items associated with the sub-exchange (e.g., Item A and Item B). Additionally, the user device may display an indication of an amount associated with each item that is based on the portions indicated via the one or more user selections. For example, the user device and/or the transaction terminal may determine amounts for each item associated with the sub-exchange based on the portions indicated by the one or more user selections. For example, for the Item A, the portion indicated by the user selection is 50%. Therefore, the user device and/or the transaction terminal may determine that the amount associated with Item A for the sub-exchange is $5 (e.g., 50% of $10). Similarly, for the Item B, the portion indicated by the user selection is 100%. Therefore, the user device and/or the transaction terminal may determine that the amount associated with Item B for the sub-exchange is $25 (e.g., 100% of $25). The user device and/or the transaction terminal may determine a total amount associated with the sub-exchange based on the amounts for each item associated with the sub-exchange. For example, as shown in FIG. 1B, the total amount for the sub-exchange may be $30 (e.g., $25+$5=$30).

In some implementations, the total amount for the sub-exchange may also include other amounts, such as an amount for tax and/or gratuity, among other examples. For example, the user device may display a field (e.g., not shown in FIG. 1B) to enable a user to input an amount for gratuity associated with the sub-exchange. This may reduce complexity associated with splitting the exchange among multiple users by enabling each user to add an amount for gratuity on to the total amount for the sub-exchange (e.g., rather than requiring an amount for gratuity to be determined for the total amount associated with the exchange).

As shown in FIG. 1B, the user device may display one or more options for submitting payment information for the sub-exchange. For example, the user device may display an option for submitting payment credentials (e.g., credential information), such as a card number, for a transaction device or a transaction card. As another example, the user device may display an option for paying using a digital wallet. For example, an exchange medium may be linked with, or associated with, the user device via a digital wallet that stores credential information for the exchange medium. As another example, the user device may display an option for paying using a payment application executing on the user device. For example, the user may pay for the sub-exchange using a third-party payment application associated with the user. The user device may receive credential information associated with an exchange medium to be used to complete a transfer associated with the sub-exchange via an input to the GUI using one or more of the options described above.

As shown in FIG. 1C, and by reference number 120, the user device (e.g., user device A) may transmit, and the transaction terminal may receive, sub-exchange information, such as the subset of items associated with the sub-exchange (e.g., Item A and Item B), an amount associated with each item included in the subset of items (e.g., $5 for Item A and $25 for Item B), and/or a total amount associated with the sub-exchange (e.g., $30), among other examples. Additionally, the user device may transmit, and the transaction terminal may receive, credential information for an exchange medium to be used to complete a transfer (e.g., a transaction) for the sub-exchange. For example, the user device may receive or obtain the credential information via a user input or user selection (e.g., via the GUI as described and depicted in FIG. 1B). The credential information may include a transaction card number (e.g., and/or an expiration date of the transaction card or a security code associated with the transaction card), an exchange medium identifier, an account identifier, and/or another identifier used to identify an account to be associated with the sub-exchange.

The transaction terminal may generate a bill for the sub-exchange based on the sub-exchange information. For example, the transaction terminal may generate a transaction or an exchange for the sub-exchange based on the sub-exchange information. As shown by reference number 122, the transaction terminal may communicate with the transaction backend system to complete the transaction for the sub-exchange. For example, the transaction terminal may transmit, to the transaction backend system, a request to approve the transaction for the sub-exchange, an indication of the total amount associated with the sub-exchange, an indication of the credential information associated with the exchange medium, and/or other identifying information associated with the transaction (e.g., such as a transaction date, a transaction time, an identifier of the entity, and/or a transaction location), among other examples. The transaction backend system may analyze the information provided by the transaction terminal and determine whether to approve the transaction for the sub-exchange. If the transaction backend system determines that the transaction is approved, then the transaction terminal may transmit an indication, to the transaction terminal, that the transaction for the sub-exchange is approved. If the transaction backend system determines that the transaction is denied, then the transaction terminal may transmit an indication, to the transaction terminal, that the transaction for the sub-exchange is denied. If the transaction is denied, then the transaction terminal may transmit, to the user device associated with the sub-exchange (e.g., user device A), an indication that the transaction for the sub-exchange is denied.

If the transaction is denied, then the transaction terminal may not update exchange information and/or presentation information associated with the exchange. However, if the transaction associated with the sub-exchange is approved, then the transaction terminal may update exchange information and/or presentation information associated with the exchange (e.g., as shown by reference number 124). For example, the transaction terminal may update exchange information associated with the exchange based on the sub-exchange information. For example, the transaction terminal may update presentation information and/or exchange information associated with the exchange based on a sub-exchange being successfully completed and/or approved.

For example, the original exchange information may indicate that the exchange is associated with Item A (e.g., for $10), Item B (e.g., for $25), Item C, (e.g., for $5) and Item D (e.g., for $15) and a total amount of $55. The sub-exchange information may indicate that Item A is 50% paid for and Item B is 100% paid for by the sub-exchange. Therefore, the transaction terminal may update the exchange information to indicate that 50% (or $5) of the item amount for Item A is remaining, 0% of the item amount for Item B is remaining, 100% of the item amount for item C is remaining, and 100% of the item amount for item D is remaining, resulting in an updated amount of $25 for the exchange (e.g., based on the $30 paid as part of the sub-exchange with user device A).

The transaction terminal may update presentation information to be provided to the user device(s) associated with the exchange. The updated presentation information may indicate updated item amounts for each item associated with the exchange. In some implementations, the updated presentation information may indicate an updated total amount associated with the exchange. In some implementations, the updated presentation information may make items that have been 100% paid for not selectable by users (e.g., via a GUI). In some implementations, the updated presentation information may cause GUI(s) of user device(s) associated with the exchange to display user selection options that limit items that can be selected or that limit a portion of an item amount for an item that can be selected (e.g., as described in more detail in connection with FIG. 1D).

As shown by reference number 126, the transaction terminal may transmit, and the user device(s) may receive, the updated presentation information. In some implementations, the transaction terminal may transmit (e.g., to a server device associated with the application executing on the transaction terminal) a message that causes the updated presentation information to be displayed via GUI(s) of the user device(s). In this way, the transaction terminal may update information displayed remotely at the user device(s) for the exchange based on sub-exchange(s) that are completed in real-time. This may enable the transaction terminal to ensure that the same item is not paid for twice by different users and/or to ensure that not more than 100% of an item amount of an item is paid for, among other examples. Additionally, this provides a more efficient manner in which to display the information associated with the exchange by enabling the user devices to display updated exchange information based on real-time updates from the transaction terminal.

As shown in FIG. 1D, and by reference number 128, a second user device associated with the exchange (e.g., the user device B as shown in FIG. 1D) may cause the updated presentation information to be displayed via a GUI of the user device. The second user device may receive the presentation information in a similar manner as described elsewhere herein (e.g., such as in connection with FIG. 1B). The updated presentation information may be received by the second user device via a message (e.g., from the transaction terminal or from a server device) or via scanning the non-textual image in a similar manner as described above. For example, the user device may insert code, or modify code inserted into, a document (e.g., a DOM) used to generate a page being displayed by the user device. In some implementations, an application executing on the second user device may update the information being displayed via the GUI based on the updated presentation information (e.g., the application may retrieve the updated presentation information from the transaction terminal or a server device). In some implementations, the transaction terminal may cause information displayed by a page (e.g., a web page or a page associated with an application) to be modified based on the updated presentation information, as described above.

As shown in FIG. 1D, the second user device may display, via the GUI, an indication of the set of items (e.g., Item A, Item B, Item C, and Item D) associated with the exchange. The second user device may display, via the GUI, an item amount associated with each item that is updated based on the sub-exchange being completed (e.g., $5 for Item A, $25 for Item B, $5 for Item C, and $15 for Item D). The second user device may display, via the GUI, the total amount associated with the exchange that is updated based on the sub-exchange being completed (e.g., $25). Additionally, the user device may display one or more user selection options that enable sub-exchanges to be generated for the exchange. For example, the second user device may display a first user selection option to enable a selection of an item from the set of items. As shown in FIG. 1D, the first user selection option may prevent or restrict a selection of one or more items. For example, the updated presentation information may cause a user selection option for the Item B to be not available for selection by the user of the second user device (e.g., as indicated by the gray color text in FIG. 1D). Because Item B was completely paid for in the sub-exchange (e.g., as described above), the updated presentation information may prevent another user for paying any amount toward the item amount of Item B.

However, because item A was only partially paid for in the sub-exchange, the Item A may still be available for selection after the second user device receives the updated presentation information. As shown in FIG. 1D, an updated item amount associated with the Item A may be displayed (e.g., $5), indicating a remaining amount to be paid for the Item A. Alternatively, the actual item amount for the Item A (e.g., $10) may be displayed and the user selection option that enables the user to select a portion of the item amount may be restricted such that a user is not able to select more than a remaining amount for the Item A (e.g., 50%). In other words, the updated presentation information, for items that have been partially paid for by a previous sub-exchange, may cause the GUI to present user selection options that limit an amount that can be allocated for a subsequent sub-exchange, such that the total amount paid (e.g., from two or more sub-exchanges) for an item does not exceed the total item amount associated with the item. This may reduce a complexity associated with handling multiple sub-exchanges associated with the same exchange by avoiding scenarios where a total amount paid for a single item exceeds the item amount associated with the item and/or scenarios where two or more users pay for the same item multiple times.

As shown by reference number 130, the second user device (e.g., the user device B) may receive user selections for a sub-exchange (e.g., a second sub-exchange) associated with a user of the second user device. For example, as shown in FIG. 1D, the user selections may indicate that 100% of the remaining amount for Item A and 100% of the item amount for Item C are to be associated with the sub-exchange.

As shown by reference number 132, the second user device may cause information for the sub-exchange to be displayed (e.g., via the GUI). For example, in some implementations, the second user device may modify the code inserted into, or may insert new code into, the document (e.g., the DOM) used to generate the page being displayed by the second user device to cause the page to display the information associated with the sub-exchange. In some implementations, the second user device may transmit, and the transaction terminal may receive, an indication of the information associated with the sub-exchange. This may enable the transaction terminal to generate a bill for the sub-exchange. Additionally, this may enable the transaction terminal to generate presentation information for the sub-exchange (e.g., indicating the subset of items associated with the sub-exchange, the amounts associated with each item of the sub-exchange, and/or a total amount associated with the sub-exchange). In some implementations, receiving the one or more user selection options may cause the user device to navigate to a new web page or to open a new page associated with an application executing on the user device. The new web page or the new page may display the information associated with the sub-exchange, as shown in FIG. 1D.

For example, as shown in FIG. 1D, the user device may display an indication of the subset of items associated with the sub-exchange (e.g., Item A and Item C). Additionally, the second user device may display an indication of an amount associated with each item that is based on the portions indicated via the one or more user selections. For example, the second user device and/or the transaction terminal may determine amounts for each item associated with the sub-exchange based on the portions indicated by the one or more user selections. For example, for the Item A, the portion indicated by the user selection is 100% of the remaining amount of $5 (or 50% of the total amount of $10 in some other examples). For example, the second sub-exchange may be associated with the remaining portion of the item amount for Item A. Therefore, the second user device and/or the transaction terminal may determine that the amount associated with Item A for the sub-exchange is $5. Similarly, for the Item C, the portion indicated by the user selection is 100%. Therefore, the second user device and/or the transaction terminal may determine that the amount associated with Item C for the sub-exchange is $5 (e.g., 100% of $5). The second user device and/or the transaction terminal may determine a total amount associated with the sub-exchange based on the amounts for each item associated with the sub-exchange. For example, as shown in FIG. 1D, the total amount for the sub-exchange may be $10 (e.g., $5+$5=$10).

In some implementations, the total amount for the sub-exchange may also include other amounts, such as an amount for tax and/or gratuity, among other examples, in a similar manner as described elsewhere herein. As shown in FIG. 1D, the second user device may display one or more options for submitting payment information for the sub-exchange in a similar manner as described elsewhere herein. The user device (e.g., user device B) may receive credential information associated with an exchange medium to be used to complete a transfer associated with the sub-exchange via an input to the GUI using one or more of the options described above.

As shown in FIG. 1E, and by reference number 134, a user device (e.g., user device B or user device C) may transmit, to the transaction terminal, information associated with additional sub-exchanges. For example, the user device B may transmit an indication of information for the sub-exchange for Item A and Item C, as described above. As shown by reference number 136, the transaction terminal may communicate with the transaction backend system to complete a transfer (e.g., a transfer of resources) associated with the additional sub-exchange(s). For example, the transaction terminal may transmit, to the transaction backend system, a request to complete a transfer for the sub-exchange associated with the user device B. The request may indicate the credential information indicated by the user device B and information associated with the sub-exchange, such as a total amount of the sub-exchange (e.g., $10). The transaction terminal may receive, from the transaction backend system, an indication of whether the transfer associated with the sub-exchange is approved, in a similar manner as described above.

If the transaction backend system indicates that the sub-exchange associated with the user device B is approved, then the transaction terminal may update presentation information and/or exchange information associated with the exchange in a similar manner as described elsewhere herein. For example, the transaction terminal may update the exchange information to indicate that 100% of Item A has been paid for and that 100% of Item C has been paid for (e.g., leaving only Item D as unpaid). The transaction terminal may cause the updated presentation information to be displayed via the user device(s) associated with the exchange in a similar manner as described elsewhere herein. The transaction terminal may complete a transfer for a sub-exchange associated with the user device C in a similar manner as described elsewhere herein.

As shown by reference number 138, the transaction terminal may identify one or more unclaimed items based on sub-exchanges associated with the exchange. An unclaimed item may be an item associated with the exchange that has at least a portion of the item amount remaining after all sub-exchanges associated with the exchange are completed. In some implementations, the transaction terminal may determine that all sub-exchanges associated with the exchange are completed based on an indication received from at least one of the user devices associated with the exchange or based on an input received from an employee of the entity. In some implementations, the transaction terminal may determine that all sub-exchanges associated with the exchange are completed based on an amount of time from a last completed sub-exchange satisfying a time threshold. After determining that all sub-exchanges associated with the exchange are completed, the transaction terminal may analyze the most recently updated exchange information to determine if any items associated with the exchange have a remaining item amount to be paid (e.g., to determine if there are any unclaimed items associated with the exchange). For example, the transaction terminal may determine that Item D is an unclaimed item. In other words, after sub-exchanges associated with user device A, user device B, and/or user device C are completed, the transaction terminal may determine that 100% of the item amount (e.g., $15) associated with Item D has not been paid (e.g., no sub-exchanges associated with the exchange have paid for the Item D).

The transaction terminal may be enabled to identify an unclaimed item based on updated exchange information associated with the exchange based on received sub-exchange information, as described above. For example, because the transaction terminal updates the exchange information in real-time based on the sub-exchange information received from different user devices associated with the exchange, the transaction terminal may be enabled to coordinate the different sub-exchanges to track the items that have been paid for and the items that have not been paid for associated with the exchange. As a result, once all sub-exchanges associated with the exchange are completed, the transaction terminal may be enabled to quickly and easily identify any unclaimed items and the amount associated with each unclaimed item that has not yet been paid. This may conserve processing resources and/or reduce a complexity associated with coordinating multiple sub-exchanges associated with different users and/or different user devices associated with the same exchange while ensuring that item amounts of all items and/or a total amount for the exchange is paid.

In some implementations, as shown by reference number 140, the transaction terminal may allocate an amount of the unclaimed item(s) associated with the exchange to user(s) associated with the exchange. For example, as part of submitting a sub-exchange, an indication may be provided for display via the GUI(s) of the user device(s) that any unclaimed items associated with the exchange may be charged to the exchange medium provided. For example, an agreement as part of using a service or application for enabling sub-exchanges may be that an amount for unclaimed items associated with the exchange may be charged to the exchange medium provided by a user.

In some implementations, the transaction terminal may split an amount associated with the unclaimed item(s) among users who completed sub-exchanges associated with the exchange. For example, an amount associated with the unclaimed item(s) may be allocated to exchange mediums associated with sub-exchanges that are associated with the exchange. For example, as shown in FIG. 1D, the transaction terminal may split the amount associated with the unclaimed item(s) equally among the users who completed sub-exchanges associated with the exchange. As shown in FIG. 1D, the unclaimed item may be Item D associated with an item amount of $15. Therefore, the transaction terminal may allocate $5 to a first user associated with user device A, $5 to a second user associated with user device B, and $5 to a third user associated with user device C (e.g., assuming a sub-exchange associated with the user device C is completed or based on the transaction terminal receiving an indication that user device C is associated with the exchange, such as by the user device C ordering an item as described in connection with FIG. 1A). In some other implementations, the transaction terminal may split the amount associated with the unclaimed item(s) in accordance with a different distribution (e.g., that is not an equal split). For example, a user device associated with the exchange may indicate the distribution and the transaction terminal may split the amount associated with the unclaimed item(s) in accordance with the distribution.

As shown by reference number 142, the transaction terminal may communicate with the transaction backend system to complete transfers for allocated amounts of the unclaimed item(s) associated with the exchange. For example, the transaction terminal may obtain or identify credential information provided as part of completing the sub-exchanges associated with the exchange. The transaction terminal may complete one or more transfers for the amount associated with the unclaimed item(s). Alternatively, when completing a sub-exchange, the transaction terminal may obtain approval for a transfer associated with the sub-exchange, but may not complete the sub-exchange. Therefore, the transaction terminal may obtain approval for an added amount associated with the unclaimed item(s) (e.g., $5 as shown in FIG. 1E) to be added to the amount associated with each sub-exchange. Therefore, a single transfer or a single transaction may be completed for the sub-exchange and the amount associated with the unclaimed item(s). This may conserve resources (e.g., processing resources and/or communication resources) that would have otherwise been used to complete multiple transfers or multiple transactions associated with the same user for a sub-exchange and an amount associated with the unclaimed item(s).

In some implementations, rather than, or in addition to, automatically completing transfers or transactions for the amount of the unclaimed item(s) associated with the exchange, the transaction terminal may perform one or more actions based on identifying the unclaimed item(s). For example, in some implementations, the transaction terminal may transmit, to one or more (or all) user devices associated with the exchange, an indication of, or an alert indicating, the unclaimed item(s). In some implementations, this may cause the user device(s) to display a notification (e.g., a push notification) indicating that there are unclaimed item(s) associated with the exchange. In some implementations, the transaction terminal may transmit, to one or more (or all) user devices associated with the exchange, an indication of an additional amount allocated to the users associated with the user devices based on the unclaimed item(s). In some implementations, the transaction terminal may cause a notification to be displayed (e.g., by the transaction terminal or by another device) to alert an employee associated with the entity (e.g., the entity associated with the transaction terminal) that there are unclaimed item(s) associated with the exchange. As a result, the action(s) performed by the transaction terminal may notify user(s) associated with the exchange and/or employees associated with the entity that there are unclaimed item(s) associated with the exchange to enable the user(s) and/or the employees to perform an action to ensure that the unclaimed item(s) associated with the exchange are paid for.

As indicated above, FIGS. 1A-1E are provided as an example. Other examples may differ from what is described with regard to FIGS. 1A-1E.

FIG. 2 is a diagram of an example environment 200 in which systems and/or methods described herein may be implemented. As shown in FIG. 2, environment 200 may include a transaction terminal 210, a transaction device 220, a user device 230, a transaction backend system 240, and a network 250. Devices of environment 200 may interconnect via wired connections and/or wireless connections.

The transaction terminal 210 includes one or more devices capable of facilitating an electronic transaction associated with the transaction device 220. For example, the transaction terminal 210 may include a point-of-sale (PoS) terminal, a payment terminal (e.g., a credit card terminal, a contactless payment terminal, a mobile credit card reader, or a chip reader), and/or an automated teller machine (ATM). The transaction terminal 210 may include one or more input components and/or one or more output components to facilitate obtaining data (e.g., account information) from the transaction device 220 and/or to facilitate interaction with and/or authorization from an owner or accountholder of the transaction device 220. Example input components of the transaction terminal 210 include a number keypad, a touchscreen, a magnetic stripe reader, a chip reader, and/or a radio frequency (RF) signal reader (e.g., a near-field communication (NFC) reader). Example output devices of transaction terminal 210 include a display and/or a speaker.

The transaction device 220 includes one or more devices capable of being used for an electronic transaction. In some implementations, the transaction device 220 includes a transaction card (or another physical medium with integrated circuitry) capable of storing and communicating account information, such as a credit card, a debit card, a gift card, an ATM card, a transit card, a fare card, and/or an access card. In some implementations, the transaction device 220 may be the user device 230 or may be integrated into the user device 230. For example, the user device 230 may execute an electronic payment application capable of performing functions of the transaction device 220 described herein. Thus, one or more operations described herein as being performed by the transaction device 220 may be performed by a transaction card, the user device 230, or a combination thereof.

The transaction device 220 may store account information associated with the transaction device 220, which may be used in connection with an electronic transaction facilitated by the transaction terminal 210. The account information may include, for example, an account identifier that identifies an account (e.g., a bank account or a credit account) associated with the transaction device 220 (e.g., an account number, a card number, a bank routing number, and/or a bank identifier), a cardholder identifier (e.g., identifying a name of a person, business, or entity associated with the account or the transaction device 220), expiration information (e.g., identifying an expiration month and/or an expiration year associated with the transaction device 220), and/or a credential (e.g., a payment token). In some implementations, the transaction device 220 may store the account information in tamper-resistant memory of the transaction device 220, such as in a secure element. As part of performing an electronic transaction, the transaction device 220 may transmit the account information to the transaction terminal 210 using a communication component, such as a magnetic stripe, an integrated circuit (IC) chip (e.g., a EUROPAY®, MASTERCARD®, VISA® (EMV) chip), and/or a contactless communication component (e.g., an NFC component, an RF component, a Bluetooth component, and/or a Bluetooth Low Energy (BLE) component). Thus, the transaction device 220 and the transaction terminal 210 may communicate with one another by coming into contact with one another (e.g., using a magnetic stripe or an EMV chip) or via contactless communication (e.g., using NFC).

The user device 230 includes one or more devices capable of being used for an electronic transaction, as described above in connection with the transaction device 220. The user device 230 may include a communication device and/or a computing device. For example, the user device 230 may include a wireless communication device, a mobile phone, a user equipment, a tablet computer, a wearable communication device (e.g., a smart wristwatch, a pair of smart eyeglasses, a head mounted display, or a virtual reality headset), or a similar type of device. Additionally, or alternatively, the user device 230 may be capable of receiving, generating, storing, processing, and/or providing information associated with inserting code into a DOM of a GUI to enable sub-exchanges, as described elsewhere herein.

The transaction backend system 240 includes one or more devices capable of processing, authorizing, and/or facilitating a transaction. For example, the transaction backend system 240 may include one or more servers and/or computing hardware (e.g., in a cloud computing environment or separate from a cloud computing environment) configured to receive and/or store information associated with processing an electronic transaction. The transaction backend system 240 may process a transaction, such as to approve (e.g., permit, authorize, or the like) or decline (e.g., reject, deny, or the like) the transaction and/or to complete the transaction if the transaction is approved. The transaction backend system 240 may process the transaction based on information received from the transaction terminal 210, such as transaction data (e.g., information that identifies a transaction amount, a merchant, a time of a transaction, a location of the transaction, or the like), account information communicated to the transaction terminal 210 by the transaction device 220, and/or information stored by the transaction backend system 240 (e.g., for fraud detection).

The transaction backend system 240 may be associated with a financial institution (e.g., a bank, a lender, a credit card company, or a credit union) and/or may be associated with a transaction card association that authorizes a transaction and/or facilitates a transfer of funds. For example, the transaction backend system 240 may be associated with an issuing bank associated with the transaction device 220, an acquiring bank (or merchant bank) associated with the merchant and/or the transaction terminal 210, and/or a transaction card association (e.g., VISA® or MASTERCARD®) associated with the transaction device 220. Based on receiving information associated with the transaction device 220 from the transaction terminal 210, one or more devices of the transaction backend system 240 may communicate to authorize a transaction and/or to transfer funds from an account associated with the transaction device 220 to an account of an entity (e.g., a merchant) associated with the transaction terminal 210.

The network 250 includes one or more wired and/or wireless networks. For example, the network 250 may include a cellular network, a public land mobile network, a local area network, a wide area network, a metropolitan area network, a telephone network, a private network, the Internet, and/or a combination of these or other types of networks. The network 250 enables communication among the devices of environment 200. In some implementations, the transaction terminal 210 may communicate with the transaction device 220 using a first network (e.g., a contactless network or by coming into contact with the transaction device 220) and may communicate with the transaction backend system 240 using a second network.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the transaction terminal 210, the transaction device 220, the user device 230, and/or the transaction backend system 240. In some implementations, the transaction terminal 210, the transaction device 220, the user device 230, and/or the transaction backend system 240 may include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

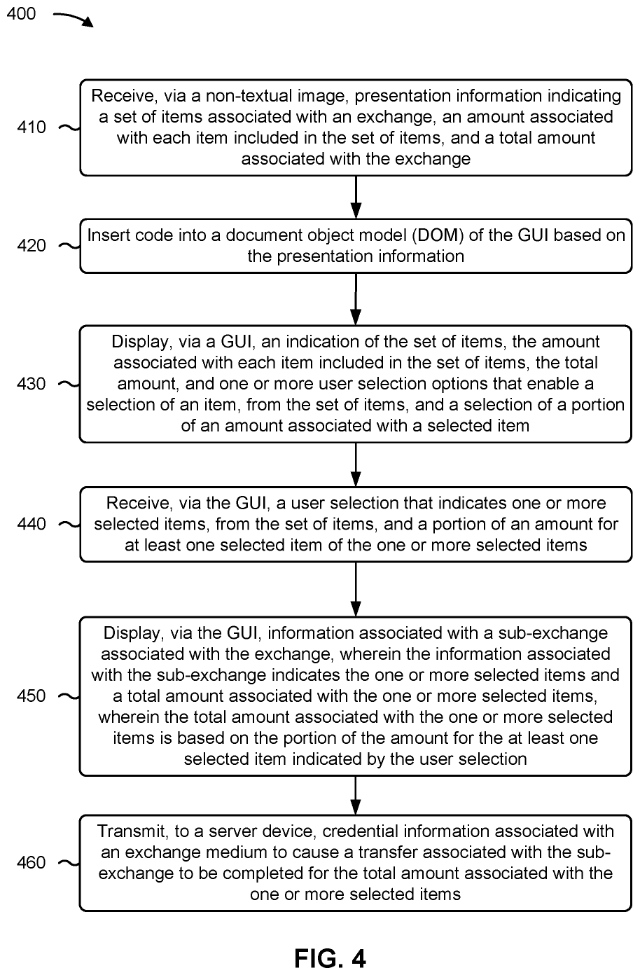

FIG. 4 is a flowchart of an example process 400 associated with inserting code into a DOM of a GUI to enable sub-exchanges. In some implementations, one or more process blocks of FIG. 4 may be performed by a device (e.g., the user device 230). In some implementations, one or more process blocks of FIG. 4 may be performed by another device or a group of devices separate from or including the device, such as the transaction terminal 210, the transaction device 220, and/or the transaction backend system 240. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving, via a non-textual image, presentation information indicating a set of items associated with an exchange, an amount associated with each item included in the set of items, and a total amount associated with the exchange (block 410). As further shown in FIG. 4, process 400 may include inserting code into the document object model (DOM) of the GUI based on the presentation information (block 420). In some implementations, the code causes an indication of the set of items, the amount associated with each item, and the total amount to be provided for display by the GUI. As further shown in FIG. 4, process 400 may include displaying, via the GUI, an indication of the set of items, the amount associated with each item included in the set of items, the total amount, and one or more user selection options that enable a selection of an item, from the set of items, and a selection of a portion of an amount associated with a selected item (block 430). As further shown in FIG. 4, process 400 may include receiving, via the GUI, a user selection that indicates one or more selected items, from the set of items, and a portion of an amount for at least one selected item of the one or more selected items (block 440). As further shown in FIG. 4, process 400 may include displaying, via the GUI, information associated with a sub-exchange associated with the exchange (block 450). In some implementations, the information associated with the sub-exchange indicates the one or more selected items and a total amount associated with the one or more selected items. In some implementations, the total amount associated with the one or more selected items is based on the portion of the amount for the at least one selected item indicated by the user selection. As further shown in FIG. 4, process 400 may include transmitting, to a server device, credential information associated with an exchange medium to cause a transfer associated with the sub-exchange to be completed for the total amount associated with the one or more selected items (block 460).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

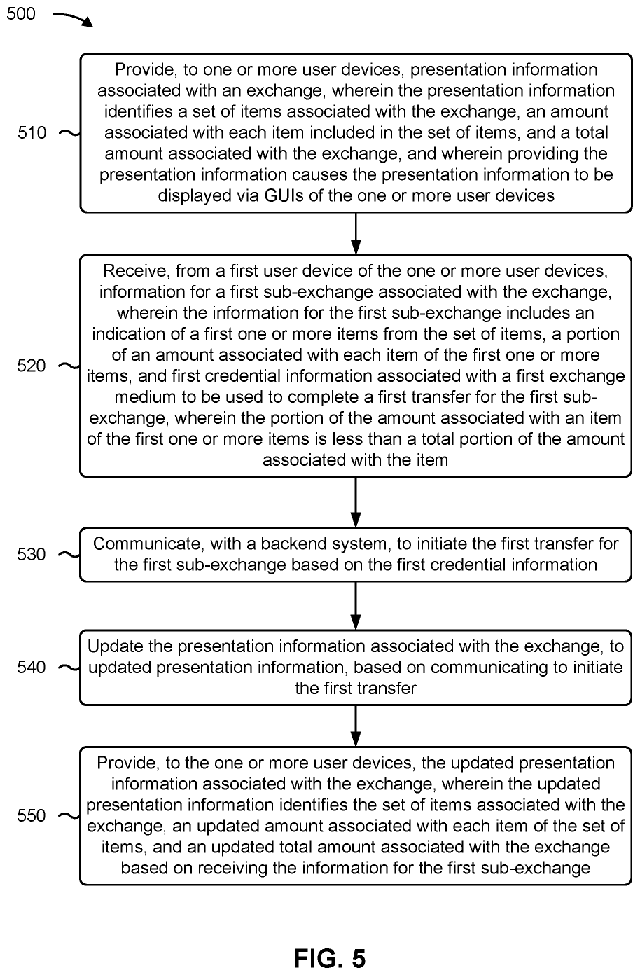

FIG. 5 is a flowchart of an example process 500 associated with inserting code into a DOM of a GUI to enable sub-exchanges. In some implementations, one or more process blocks of FIG. 5 may be performed by a device (e.g., the transaction terminal 210). In some implementations, one or more process blocks of FIG. 5 may be performed by another device or a group of devices separate from or including the device, such as the user device 230, the transaction device 220, and/or the transaction backend system 240. Additionally, or alternatively, one or more process blocks of FIG. 5 may be performed by one or more components of device 300, such as processor 320, memory 330, input component 340, output component 350, and/or communication component 360.

As shown in FIG. 5, process 500 may include providing, to one or more user devices, presentation information associated with an exchange (block 510). In some implementations, the presentation information identifies a set of items associated with the exchange, an amount associated with each item included in the set of items, and a total amount associated with the exchange. In some implementations, providing the presentation information causes the presentation information to be displayed via GUIs of the one or more user devices. As further shown in FIG. 5, process 500 may include receiving, from a first user device of the one or more user devices, information for a first sub-exchange associated with the exchange (block 520). In some implementations, the information for the first sub-exchange includes an indication of a first one or more items from the set of items, a portion of an amount associated with each item of the first one or more items, and first credential information associated with a first exchange medium to be used to complete a first transfer for the first sub-exchange. In some implementations, the portion of the amount associated with an item of the first one or more items is less than a total portion of the amount associated with the item. As further shown in FIG. 5, process 500 may include communicating, with a backend system, to initiate the first transfer for the first sub-exchange based on the first credential information (block 530). As further shown in FIG. 5, process 500 may include updating the presentation information associated with the exchange, to updated presentation information, based on communicating to initiate the first transfer (block 540). As further shown in FIG. 5, process 500 may include providing, to the one or more user devices, the updated presentation information associated with the exchange (block 550). In some implementations, the updated presentation information identifies the set of items associated with the exchange, an updated amount associated with each item of the set of items, and an updated total amount associated with the exchange based on receiving the information for the first sub-exchange.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A non-transitory computer-readable medium storing a set of instructions for providing a graphical user interface (GUI) to enable sub-exchanges by inserting code into a document object model of the GUI, the set of instructions comprising:
one or more instructions that, when executed by one or more processors of a device, cause the device to:
receive presentation information indicating a set of items associated with an exchange, an amount associated with each item included in the set of items, and a total amount associated with the exchange;
insert the code into the document object model of the GUI based on the presentation information, wherein the code causes an indication of the set of items, the amount associated with each item, and the total amount to be provided for display by the GUI;
provide the GUI for display by the device based on inserting the code into the document object model;
receive, via the GUI, an indication of a user selection that indicates one or more items, from the set of items, and a portion of an amount for each item of the one or more items;
modify the code to cause information for a sub-exchange associated with the exchange to be provided for display by the GUI, wherein the information for the sub-exchange indicates the one or more items, an amount for each item that is based on the portion of the amount, and a total amount associated with the sub-exchange;
provide the GUI for display by the device based on modifying the code; and
transmit, to a server device, credential information associated with an exchange medium to cause a transfer associated with the sub-exchange to be completed.

2. The non-transitory computer-readable medium of claim 1, wherein the one or more instructions, when executed by the one or more processors, further cause the device to:
receive, based on the transfer associated with the sub-exchange being successfully completed, updated presentation information that indicates at least one of an updated total amount associated with the exchange, an updated set of items associated with the exchange, or an updated amount associated with at least one item from the set of items;
modify the code to cause updated information associated with the exchange to be provided for display by the GUI based on the updated presentation information; and
provide the GUI for display by the device based on modifying the code to cause the updated information associated with the exchange to be displayed by the device.

3. The non-transitory computer-readable medium of claim 1, wherein the one or more instructions, that cause the device to receive the presentation information, cause the device to:
receive a non-textual image, wherein the non-textual image is encoded with the presentation information; and
decode the non-textual image to obtain the presentation information.

4. The non-transitory computer-readable medium of claim 3, wherein the non-textual image is a Quick Response (QR) code.

5. The non-transitory computer-readable medium of claim 1, wherein the one or more instructions, when executed by the one or more processors, further cause the device to:
receive, from the server device, an indication of one or more unclaimed items from the set of items associated with the exchange, wherein a portion of an amount associated with the one or more unclaimed items is associated with a user of the device by the server device, and wherein another transfer is initiated by the server device associated with the exchange medium for the portion of the amount associated with the one or more unclaimed items.

6. The non-transitory computer-readable medium of claim 1, wherein the one or more instructions, that cause the device to provide the GUI for display by the device based on inserting the code into the document object model, cause the device to:
display the GUI indicating one or more user selection options, wherein the one or more user selection options enable a user to select an item, from the one or more items, and to indicate a portion of an amount associated with the item.

7. The non-transitory computer-readable medium of claim 6, wherein the one or more user selection options include a variable percentage option associated with each item included in the set of items for indicating a portion or percentage associated with an amount of each item.

8. The non-transitory computer-readable medium of claim 6, wherein the one or more instructions, that cause the device to receive the indication of the user selection, cause the device to:
receive the indication of the portion of the amount for each item of the one or more items via at least one user selection option of the one or more user selection options.

9. A method of providing a graphical user interface (GUI) to enable sub-exchanges, comprising:
receiving, by a device and via a non-textual image, presentation information indicating a set of items associated with an exchange, an amount associated with each item included in the set of items, and a total amount associated with the exchange;
displaying, by the device and via the GUI, an indication of the set of items, the amount associated with each item included in the set of items, the total amount, and one or more user selection options that enable a selection of an item, from the set of items, and a selection of a portion of an amount associated with a selected item;
receiving, by the device and via the GUI, a user selection that indicates one or more selected items, from the set of items, and a portion of an amount for at least one selected item of the one or more selected items;
displaying, by the device and via the GUI, information associated with a sub-exchange associated with the exchange, wherein the information associated with the sub-exchange indicates the one or more selected items and a total amount associated with the one or more selected items, wherein the total amount associated with the one or more selected items is based on the portion of the amount for the at least one selected item indicated by the user selection; and
transmitting, by the device and to a server device, credential information associated with an exchange medium to cause a transfer associated with the sub-exchange to be completed for the total amount associated with the one or more selected items.

10. The method of claim 9, further comprising:
receiving an indication of one or more unclaimed items from the set of items associated with the exchange, wherein a portion of an amount associated with the one or more unclaimed items is associated with a user of the device by the server device, and wherein another transfer is initiated by the server device associated with the exchange medium for the portion of the amount associated with the one or more unclaimed items.

11. The method of claim 9, further comprising:
transmitting, via the GUI, a selection of at least one item of the set of items to add the item to the set of items associated with the exchange.

12. The method of claim 9, wherein displaying the indication of the set of items, the amount associated with each item included in the set of items, the total amount, and one or more user selection options comprises displaying a first page associated with a main bill associated with the exchange; and
wherein displaying the information associated with a sub-exchange associated with the exchange comprises displaying a second page associated with a sub-bill associated with the exchange and the sub-exchange, wherein the second page enables a user to initiate the transfer associated with the sub-exchange.

13. The method of claim 9, wherein receiving the user selection comprises:
receiving, for a selected item of the at least one selected item, an indication of a portion or a percentage of an amount associated with the selected item, wherein the portion or the percentage of the amount is an amount associated with the selected item to be paid by a user associated with the device.

14. A system for providing a graphical user interface (GUI) to enable sub-exchanges, the system comprising:
one or more memories; and
one or more processors, coupled to the one or more memories, configured to:
provide, to one or more user devices, presentation information associated with an exchange, wherein the presentation information identifies a set of items associated with the exchange, an amount associated with each item included in the set of items, and a total amount associated with the exchange, and wherein providing the presentation information causes the presentation information to be displayed via GUIs of the one or more user devices;
receive, from a first user device of the one or more user devices, information for a first sub-exchange associated with the exchange, wherein the information for the first sub-exchange includes an indication of a first one or more items from the set of items, a portion of an amount associated with each item of the first one or more items, and first credential information associated with a first exchange medium to be used to complete a first transfer for the first sub-exchange, wherein the portion of the amount associated with an item of the first one or more items is less than a total portion of the amount associated with the item;
communicate, with a backend system, to initiate the first transfer for the first sub-exchange based on the first credential information;
update the presentation information associated with the exchange, to updated presentation information, based on communicating to initiate the first transfer; and
provide, to the one or more user devices, the updated presentation information associated with the exchange, wherein the updated presentation information identifies the set of items associated with the exchange, an updated amount associated with each item of the set of items, and an updated total amount associated with the exchange based on receiving the information for the first sub-exchange.

15. The system of claim 14, wherein the one or more processors are further configured to:
receive, from a second user device, information for a second sub-exchange associated with the exchange, wherein the information for the second sub-exchange includes an indication of a second one or more items from the set of items, a portion of an amount associated with each item of the second one or more items, and second credential information associated with a second exchange medium to be used to complete a second transfer for the first sub-exchange; and
communicate to initiate the second transfer for the second sub-exchange based on the second credential information.

16. The system of claim 15, wherein the information for the second sub-exchange indicates that the second one or more items includes the item, and that the second sub-exchange is associated with a remaining portion of the amount associated with the item.

17. The system of claim 14, wherein the GUIs are associated with an application, and wherein the one or more processors are further configured to:
identify one or more unclaimed items from the set of items and an amount associated with the one or more unclaimed items;
identify one or more exchange mediums associated with the exchange including the first exchange medium, wherein the one or more exchange mediums are indicated to the system via the application;
allocate portions of the amount associated with the one or more unclaimed items to the one or more exchange mediums such that the portions of the amount equal the amount associated with the one or more unclaimed items; and
communicate, with one or more backend systems including the backend system, to initiate one or more transfers for the portions of the amount associated with the one or more unclaimed items based on credential information associated with the one or more exchange mediums.

18. The system of claim 17, wherein the one or more processors, to allocate the portions of the amount associated with the one or more unclaimed items, are configured to:
allocate the portions equally among the one or more exchange mediums; or
allocate the portions among the one or more exchange mediums according to a distribution indicated by the first user device or another user device associated with the exchange.

19. The system of claim 14, wherein the one or more processors, to provide the presentation information associated with the exchange, are configured to:
generate a non-textual image that is encoded with the presentation information; and
perform an action to cause a receipt associated with the exchange to be printed with the non-textual image.

20. The system of claim 14, wherein the one or more processors, to provide the presentation information associated with the exchange, are configured to:
provide one or more user selection options to be displayed via the GUIs of the one or more user devices, wherein the one or more user selection options include at least one of a first user selection option to select an item of the set of items and a second user selection option to enable a user to indicate a portion of an amount associated with each selected item, wherein the portion of the amount associated with each selected item indicates an amount to be paid by a user for each selected item.
